(19) United States
(12) Patent Application Publication
(10) Pub. No.: US 2023/0254360 A1
(43) Pub. Date: Aug. 10, 2023

(54) REMOTE INSTRUCTIONAL SYTEM WITH HUMAN MACHINE INTERFACE

(71) Applicant: Victor Garcia, Orangeburg, SC (US)

(72) Inventor: Victor Garcia, Orangeburg, SC (US)

(21) Appl. No.: 17/669,125

(22) Filed: Feb. 10, 2022

(51) Int. Cl. H04L 67/025; G05B 19/02

(52) U.S. Cl. CPC H04L 67/025; G05B 19/02

(57) ABSTRACT

A remote instructional system enables remote users to control a machine which is digitally connected to a host computing device through a human machine interface. This human machine interface includes a software application operating on the host computing device, a digital adapter connecting the host computing device to the machine, a network connecting client computing devices to the host computing machine, and a graphical user interface allowing users of the client computing devices to remotely control the machine. However, the software application of the human machine interface restricts the passage of digital information from the network to the digital adapter through the host computing device to only computing pathways necessary to permit remote client devices to remotely control the machine.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of control systems of existing art and more specifically relates to remote control system for machines.

### RELATED ART

It is often advantageous to enable a remote user to access and control a particular device over a network such as an internet connection. Examples of such systems include remote administrative tools (RATs), which provide a remote user with full access and control. Other systems provide partial access or control, such as virtual meeting applications, which may enable screen sharing or other remote functions.

Unfortunately, the remote access tools known in the art are limited in their usefulness (either due to limited access mechanisms or limited allowance for multiple simultaneous users). Additionally, many remote access tools introduce a host of security concerns. Furthermore, since these remote access tools are usually purely software and network based, they are unable to lend themselves to particular technical applications which involve technology ancillary to the computing device to which remote access is provided.

U.S. Pat. No. 8,244,837 to Andrew J. Stone et al. relates to a central administration of one or more resources. The described central administration of one or more resources includes central administration tool or manager supports entry or selection of attribute data or datum (e.g., an attribute value) associated with at least one of a resource and a user. The entered or selected data is arranged into a data structure (e.g., a file) for transmission over a communications network. The data structure is transmitted over the communications network to a directory interface. The transmitted data structure is processed to be compatible with interpretation by a directory services system. The directory services system is invoked consistent with the contents of the data structure (e.g., the file) and the previous processing of the data structure. Resources (e.g., applications) that are under the control of the directory services are managed consistent with the contents of the data structure.

The patent to Stone represents modern developments in remote access software art, but is limited in its application to computing devices only, and fails to provide flexibility in simultaneously permitting multiple users to access a target system simultaneously. Accordingly, there is yet perceived a need for an improved remote access software which fulfills these deficiencies, and lends itself as an educational tool by providing multiple users with the ability to remotely control an internal combustion engine.

### SUMMARY OF THE INVENTION

In view of the foregoing disadvantages inherent in the known remote access software art, the present disclosure provides a novel remote instructional access and control sharing system. The general purpose of the present disclosure, which will be described subsequently in greater detail, is to provide a remote instructional access and control sharing system.

A remote instructional system enables remote users to control a machine which is digitally connected to a host computing device through a human machine interface. This human machine interface includes a software application operating on the host computing device, a digital adapter connecting the host computing device to the machine, a network connecting client computing devices to the host computing machine, and a graphical user interface allowing users of the client computing devices to remotely control the machine. However, the software application of the human machine interface restricts the passage of digital information from the network to the digital adapter through the host computing device to only computing pathways necessary to permit remote client devices to remotely control the machine. For example, in one application, remote client devices may be restricted to accessing the USB port to which the digital adapter is connected, the webcam of the host computing device, and the microphone of the host computing device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a remote instructional access and control sharing system, constructed and operative according to the teachings of the present disclosure.

FIG. 1 is a perspective view of the machine interface of the remote instructional access and control sharing system during an ‘in-use’ condition, according to an embodiment of the disclosure.

FIG. 2 is a diagram of the networked components of the remote interface and control system of FIG. 1, according to an embodiment of the present disclosure.

FIG. 3 is a first view of the graphical user interface of the remote instructional access and control sharing system of FIG. 1, according to an embodiment of the present disclosure.

FIG. 4 is a second view of the graphical user interface of the remote instructional access and control sharing system of FIG. 1, according to an embodiment of the present disclosure.

FIG. 5 is a third view of the graphical user interface of the remote instructional access and control sharing system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a remote access software and more particularly to a remote instructional access and control sharing system as used to improve the access by remote users to control a machine.

For the purposes of this specification, “HMI” indicates a human-machine-interface.

In the heavy equipment and automotive industries, SAE J1939 (hereafter “J1939) is a digital protocol standardizing digital controls and communications in commercial vehicles and equipment. Often, J1939 may also be referred to as CAN (Controller Area Network), although technically J1939 is based upon the older CAN. The physical and data-link layers of J1939 are defined by the ISP 11898 specification. In practice, J1939 is the digital bus standard that enables reliable use of third-party electronic device to digitally communicate with an ECU (electronic control unit) which governs an internal combustion engine.

The present invention provides a networking system enabling remote users to access remote machinery, and most particularly, J1939-based ECUs. Systems and methodologies are known in the art which can enact remote access and communications with J1939-based ECUs, but not in a way which meets the needs of instructional and corporate entities wishing to remotely share access to control an engine in a secure and controlled manner. For example, it has been known to use the screen-sharing and remote control functions of virtual business meeting software widely available on the market to control an HMI on a single computer which is physically linked to an engine using a J1939 bus and appropriate digital adapters. Unfortunately, such sharing systems give broad remote access to the local network in computer in general, which is unacceptable from a security standpoint in instructional and corporate settings in particular. Furthermore, these solutions are not tailored for these settings and applications.

The presently disclosed system is advantageous not only in tailoring a networking system for such settings and applications, but also for providing a controlled access point which limits authorized remote users to only the functions necessary to remotely control the internal combustion engine. Particularly, the software which is installed to the host machine is able to restrict remote controls to the particular data port to which the HMI is operating through. In this way, critical security concerns are not introduced by allowing remote access to a host machine which may be connected to a sensitive network, or may contain sensitive data on a hard drive.

Furthermore, the presently disclosed system is distinguished by a graphical user interface which allows remote users to view critical engine parameters in real-time, and also transmit commands to the engine. For example, commands may include (but are not necessarily limited to): start; stop; emergency stop; rev to redline; enter desired RPM. Viewable parameters may include (but are not necessarily limited to): each of torque and horsepower graphed against RPM; current RPM; current torque; current horsepower; fuel rate (fuel being consumed per unit of time); air filter differential pressure; ambient air temperature; atmospheric pressure; battery current; battery voltage; coolant level; coolant temperature; coolant pressure; crankcase pressure; engine load (%); exhaust temperature (per bank if applicable); fuel filter differential pressure; fuel pressure; fuel level; fuel temperature; oil pressure; oil temperature; total operating hours; turbocharger inlet and outlet temperatures (per turbocharger or supercharger if applicable); turbocharger inlet and outlet pressures (per turbocharger or supercharger if applicable); transmission temperature; transmission pressure. Warning indicators may include (but are not necessarily limited to): high engine coolant temperature; low engine oil level; high engine oil level; high oil filter differential pressure; high air filter differential pressure; high fuel filter differential pressure; low fuel filter differential pressure; low battery voltage.

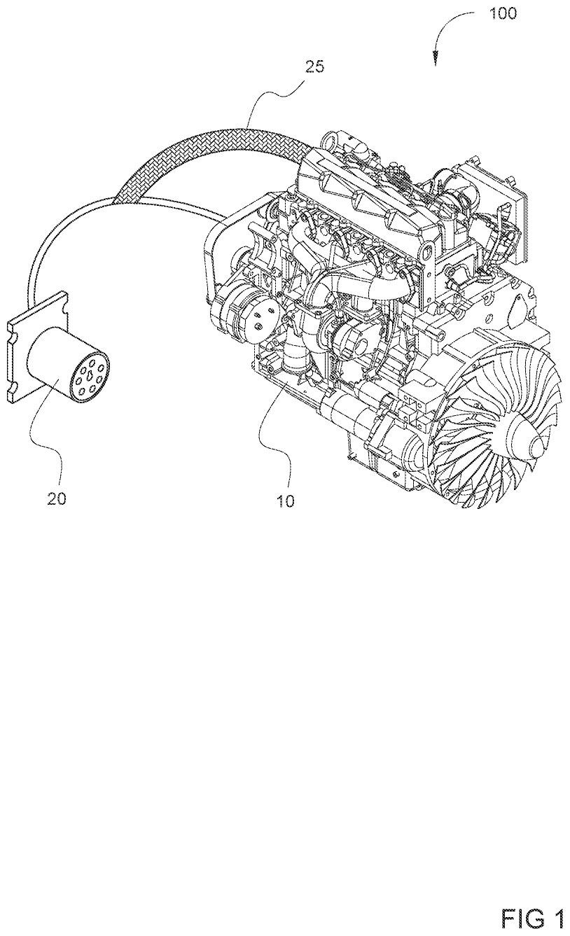

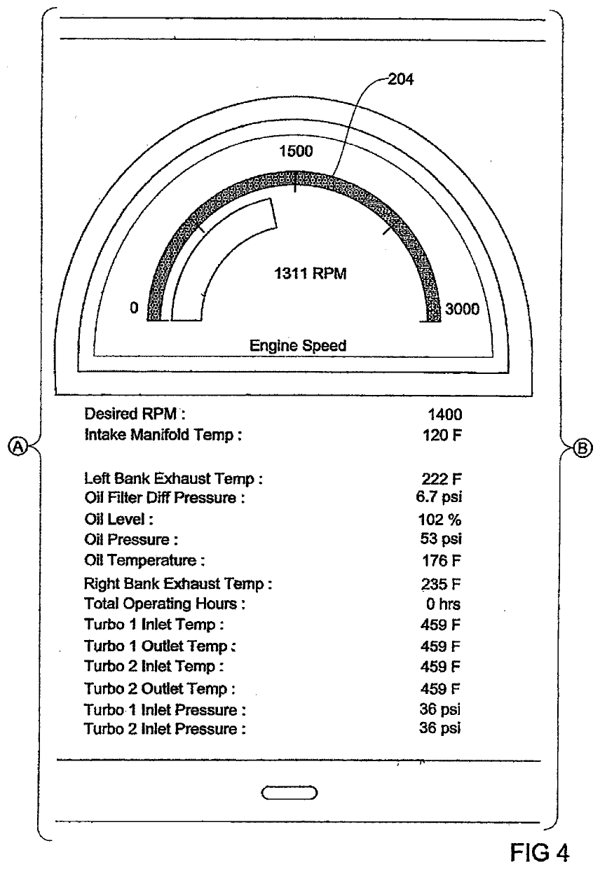

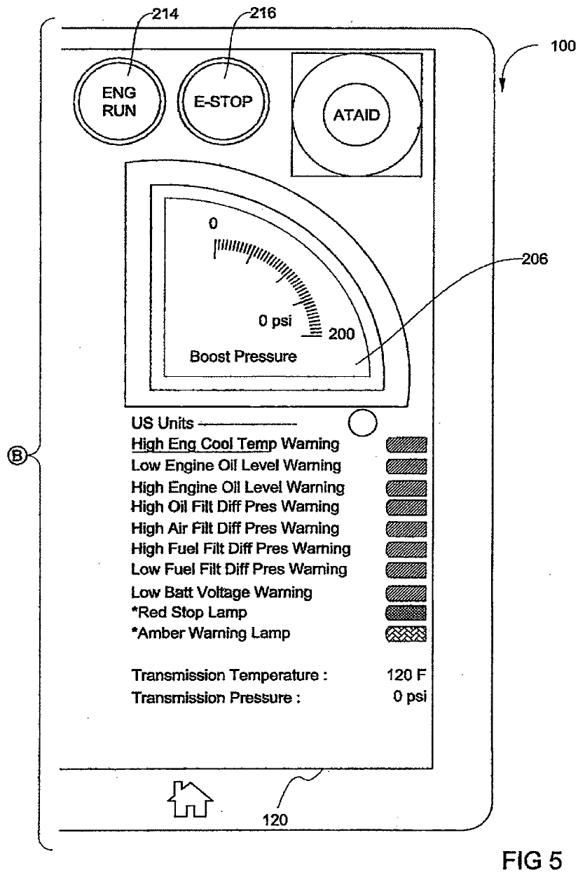

Referring now more specifically to the drawings by numerals of reference, there is shown in FIGS. 1-5, various views of a remote interface and control system 100.

FIG. 1 shows a machine interface of the remote interface and control system during an ‘in-use’ condition, according to an embodiment of the present disclosure. Here, the remote interface and control system 100 may be beneficial for use by a user to remotely access a machine 10 such as an internal combustion engine, especially for instructional purposes. Communication with and control of machine 10 may be enacted by J1939 interface 20. J1939 interface 20 may be connected to machine 10 by wire harness 25.

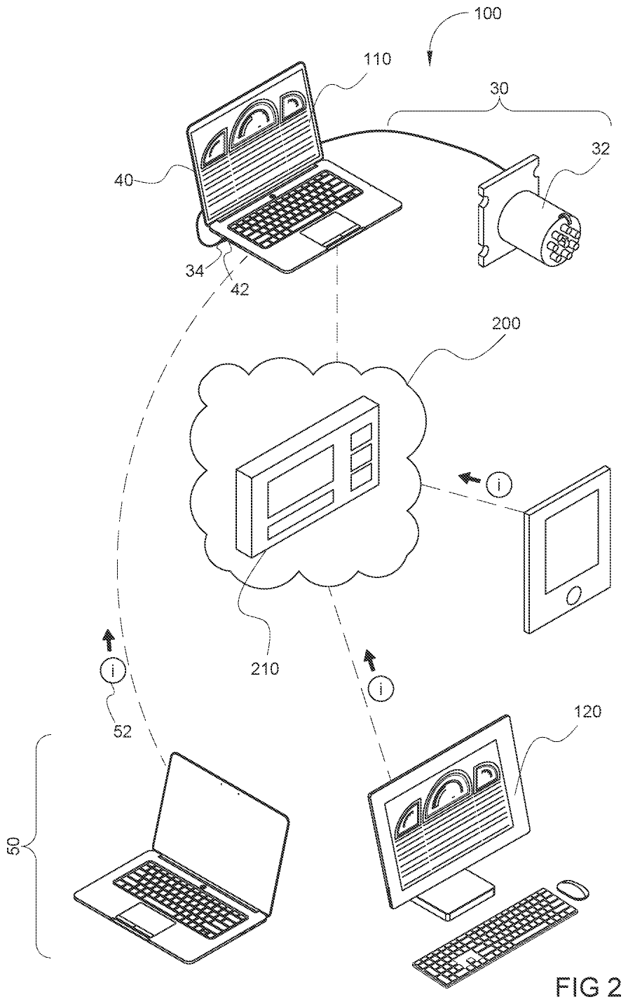

FIG. 2 is a diagram of the networked components of the remote interface and control system of FIG. 1, according to an embodiment of the present disclosure. As illustrated, remote networking system 100 may include human-machine-interfacing software program 110, electrical adapter 30, one or more remote client-end interfaces 50, virtual meeting space 210, and graphical user interface 120. Human-machine-interfacing software program 110 may hosted by computing device 40 such as a laptop or a desktop computer, although mobile devices may also be used in some embodiments. In some embodiments, computing device 40 may have a data port 42; such as a USB port, mini-USB port, USB-C port, or others. Electrical adapter 30 may be able to digitally link the data port 42 of computing device 40 to J1939 interface 20 of machine 10. In this way, computing device 40 may be electrically linked to machine 10.

Virtual meeting space 210 may be hosted on a server and accessed through network 200, such that it is accessible by authorized network-enacted logins upon any computing device 40. Virtual meeting space 210 may be able to share data 52 including webcam data, audio data, and screensharing data amongst computing device 40 and one or more remote client-end interfaces 50. Human-machine-interfacing software program 110 is able to provide remote permissions enabling one or more remote client-end interfaces 50 to digitally access the data port 42 to which electrical adapter 30 is connected via plug 34. Graphical user interface 120 may be accessible by each of one or more remote client-end interfaces 50, such that each of one or more remote client-end interfaces 50 are enabled to send commands to electrical adapter 30.

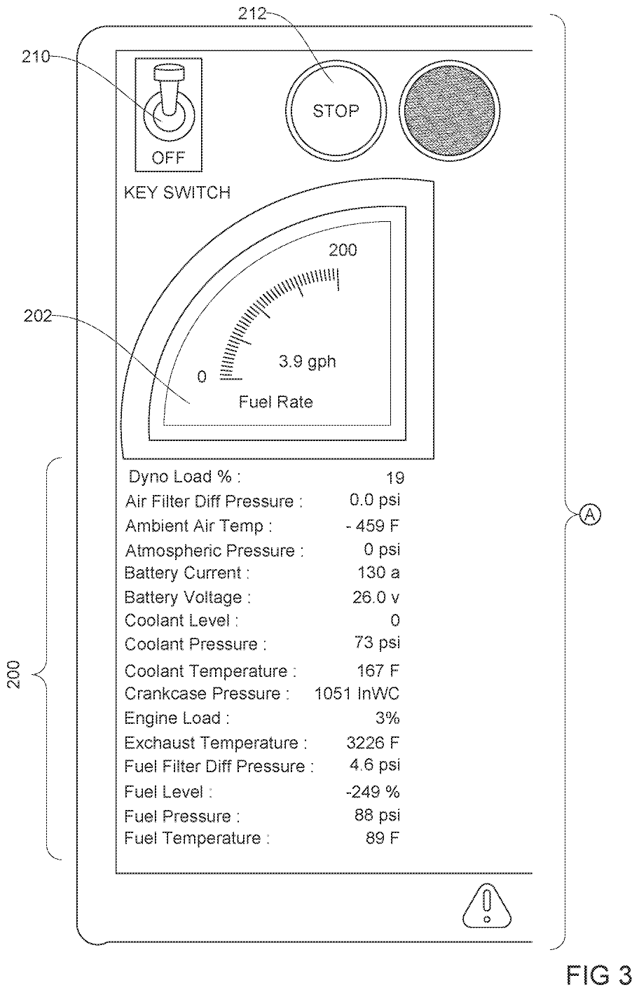

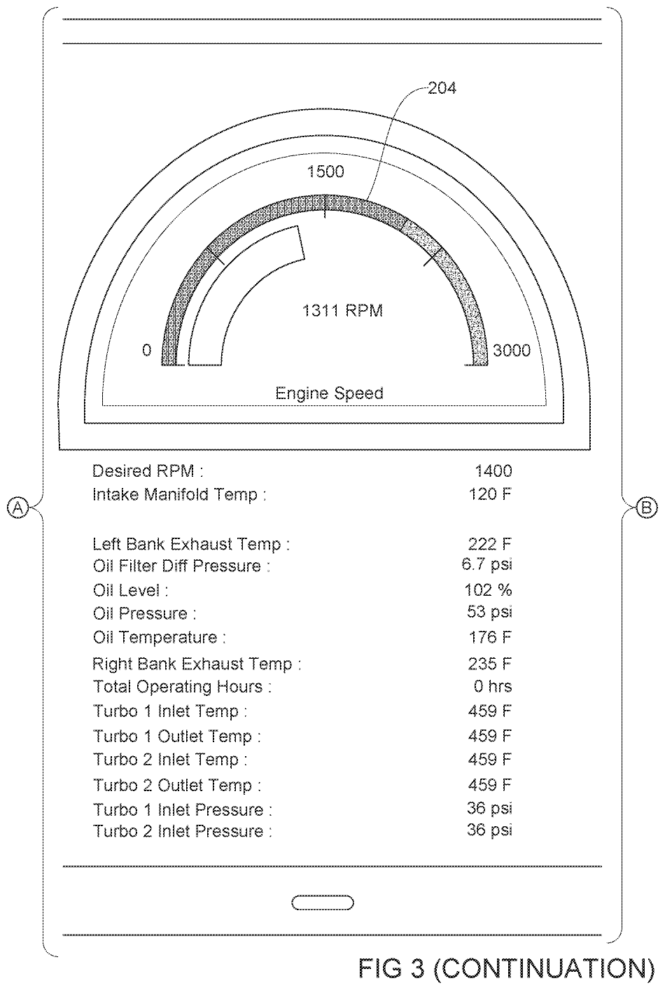

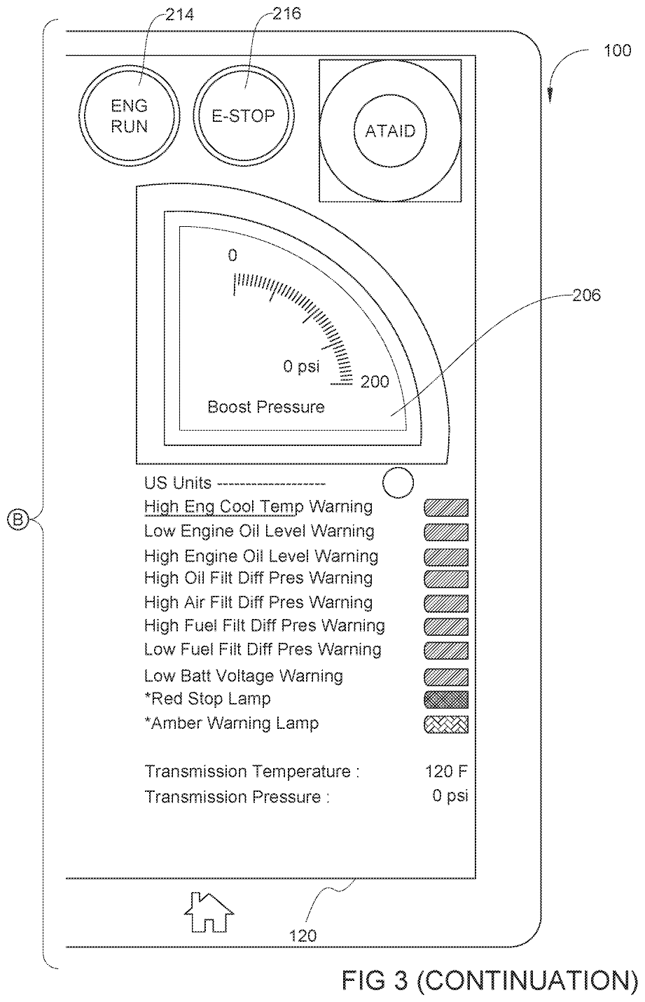

FIGS. 3-5 are complementary views of the graphical user interface of the remote instructional access and control sharing system of FIG. 1, according to an embodiment of the present disclosure. Remote networking system 100 may also have a graphical user interface 120 which is accessible by each of one or more remote client-end interfaces 50. Such graphical user interface 120 may be installed as a software application upon each remote client-end interfaces 50, or may be accessible from a server via an internet browser. However, the implementation of a software application is preferred. Graphical user interface 120 may have a plurality of digital informational readouts 200 as shown. Graphical user interface 120 may have multiple activatable buttons when can be turned on and off, or pressed, etc. by a remote user. Such activatable buttons may include a key switch 210, a virtual start button able to start the engine 214; a virtual stop button 212 able to stop the engine; and a virtual emergency stop button able to cut all power to the engine 216. Other inputs or display may include a prompt for inputting desired RPM; a fuel rate gauge 200 able to display the fuel consumed per unit of time; an RPM gauge 204; a boost gauge 206; and a graphical display plotting each of horsepower and torque against RPM.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A remote networking system providing control of an internal combustion engine to remote authorized users, the remote networking system comprising:
a human-machine-interfacing software program hosted by a computing device, the computing device having a data port;
an electrical adapter able to digitally link the data port of the computing device to a J1939 interface of the internal combustion engine;
one or more remote client-end interfaces;
a virtual meeting space hosted on a server, the virtual meeting space being able to share webcam data, audio data, and screensharing data amongst the computing device and the one or more remote client-end interfaces;
wherein the human-machine-interfacing software program is able to provide remote permissions enabling the one or more remote client-end interfaces to digitally access the data port to which the electrical adapter is connected;
a graphical user interface accessible by each of the one or more remote client-end interfaces, the graphical user interface enabling each of the one or more remote client-end interfaces to send commands to the electrical adapter.

2. The remote networking system of claim 1, further comprising a graphical user interface accessible by each of the one or more remote client-end interfaces, the graphical user interface comprising a virtual start button able to start the engine;
a virtual stop button able to stop the engine;
a virtual emergency stop button able to cut all power to the engine;
a prompt for inputting desired RPM;
a fuel rate gauge able to display the fuel consumed per unit of time;
an RPM gauge;
a graphical display plotting each of horsepower and torque against RPM.
